(19) United States
(12) Patent Application Publication
(10) Pub. No.: US 2024/0234012 A1
(43) Pub. Date: Jul. 11, 2024

(54) ELECTRIC ARRANGEMENT WITH A CHOKE COIL

(71) Applicant: Robert Bosch GmbH, Stuttgart (DE)

(72) Inventors: Wolfram Kienle, Magstadt (DE); Christoph Jatzek, Hechingen-Schlatt (DE); Friedemann Wolff, Walddorfhaeslach (DE)

(21) Appl. No.: 18/558,601

(22) PCT Filed: Apr. 25, 2022
(86) PCT No.: PCT/EP2022/060851

§ 371 Date: Nov. 2, 2023

(30) Foreign Application Priority Data
May 18, 2021 (DE) 10 2021 205 047.6

(51) Int. Cl. H01F 27/29; H01F 27/24

(52) U.S. Cl. CPC H01F 27/29; H01F 27/24

(57) ABSTRACT

The invention relates to an electric arrangement (1), which comprises: a circuit substrate (2) with a plurality of terminal clips (3); and a choke coil (4) with conductors (5) having stripped terminals (6), each stripped terminal (6) being held in one of the plurality of terminal clips (3).

### BACKGROUND

The present invention relates to an electric arrangement with a choke coil and a circuit substrate. More particularly, the present invention relates to an electrical arrangement used for controlling the traction machines of electrically driven transportation means.

Toroidal chokes are used in the filter units of electric vehicles for the electrical damping of interference frequencies. In this context, the closed shape is the electrically preferred design. However, the use of a closed choke in the filter unit structure results in the current conductor having to be threaded through the choke and then electrically connected behind it. From an electrical point of view, a dual power conductor design proves to be of great advantage because the number of turns is squared in the damping. The flow of current in the choke passage can only be cooled with great difficulty, thus leading to heating of the choke core. The need exists for a damping concept including a dual power conduction design and simple assembly.

### SUMMARY

The present invention relates to an electric arrangement with a switch substrate and a choke coil with conductors. The choke coil is arranged on the circuit substrate such that the stripped terminals of their conductors are received in a respective terminal clip, wherein in each case the stripped terminals are held in one of the plurality of terminal clips. In other words, terminal clips are mounted (e.g., glued, riveted, brazed, or the like) on the circuit substrate and have a particularly resilient support for the stripped terminals of the choke coil conductors. In this case, the terminal clips can be elastically bent upwards during insertion of the stripped terminals and can be undercut according to a predefined path through the terminal clips. In other words, the stripped end of the conductor snaps or locks into the terminal clip, and is secured against undesired removal from the terminal clip. By means of a suitable geometric design of the terminal clips, a high contact surface with the respective stripped connection of the conductors can be ensured. In particular, sections of the surfaces of the stripped terminals can correspond to the terminal clips in order to ensure that the terminal clips lie flat against the stripped terminals. In particular, the stripped terminals can have a substantially cylindrical conductor shape (e.g., depending on the type of copper wire), whereas the terminal clips have jaws arranged opposite one another with cylindrically concave surfaces. When assembled, the surface of the terminal clips thus forms a jacketed section surface for the stripped terminals. In this way, assembly is simplified compared to arrangements known in the prior art, and the positioning of the stripped terminals in the terminal clips is (at least initially) reversible so that correction is initially easily possible if the stripped terminals are initially positioned in the wrong terminal clip.

Preferably, the plurality of terminal clips can be electrically connected to a respective conductor trace on the circuit substrate. In other words, the terminal clips are electrically connected to a respective conductor trace on the circuit substrate in order to electrically connect the choke coil to the surrounding periphery. The terminal clips can be soldered, welded, riveted, conductively glued, or the like, to the conductor traces.

Preferably, the stripped terminals can also be welded onto the terminal clips. In other words, after insertion of the stripped terminals, the terminal clip can be contacted from the outside by an electrode or two electrodes such that, when an electric voltage is applied, the welding current resulting from the terminal clips and the stripped terminals leads to a bonded connection between the terminals and the terminal clips. In this case, the terminal clips can in particular also be welded onto the circuit substrate (e.g., having the respective conductor trace). This results in securing of the choke coil against mechanical and electrical decoupling from the circuit substrate.

For example, the holding clips and the choke coil can be arranged entirely on one side of the circuit substrate. In this design, all components of the choke coil (core assembly, electrical conductors, etc.) are arranged on the same side of the circuit substrate as the terminal clips. However, at least a center of gravity of the choke coil is on the same side of the circuit substrate as the terminal clips. Alternatively, the choke coil or its center of gravity can be located on a side of the circuit substrate opposite the clips, and only the electrical conductors and stripped terminals, which are proportionally guided to the opposite side of the circuit substrate, are located on the side with the terminal clips, in which case the stripped terminals are arranged in the terminal clips. Using this design, the structure is able to remain flat against a respective surface of the circuit substrate.

For example, the terminal clips can have a base comprising an even surface (mounting surface) for a flat and stable connection to the circuit substrate. Alternatively or additionally, retaining projections which curve over both sides of the base can be provided for receiving the stripped terminals. In this case, the terminal clip can be manufactured as one (bent) piece from a sheet metal part. Since the retaining projections curve over the laminar base, a resilient path for adjusting a suitable predefined preloading of the retaining projections can be ensured. The stripped terminals can in this way be retained in a particularly secure manner, and contact with the retaining projections via welding electrodes can be performed easily and reliably adjacent the stripped terminals.

In particular, the retaining projections can have a depth that is less than a depth of the base. In other words, the terminal clip, which is made from a sheet metal strip and in one respect can have a sufficiently large width/depth at the location where the base adjoins the circuit substrate in a flat manner, as well as a lower width/depth of the retaining projections curving over the base, is able to ensure that the bias on the stripped terminals is not strong enough to prevent these from reliably being inserted into the terminal clips during operation without risk to the surrounding components.

The retaining projections can comprise distal ends which, during insertion of the stripped terminals, are oriented in a direction perpendicular to the surface of the circuit substrate and initially come into contact with the stripped terminals when the choke coil is mounted. These distal ends can comprise a contact surface for the stripped terminals which is situated essentially perpendicular to the surface of the circuit substrate. In this case, two opposing distal ends clamp the stripped terminals of the conductors of the choke coil between one another. They can for this purpose comprise a gap tapering towards the surface of the circuit substrate in order to facilitate threading of the stripped terminals while ensuring a sufficiently strong bias in an end position of the stripped terminals. For this purpose, the distal ends of the stripped terminal areas in the end position can be at a greater distance from one another so that the stripped terminals, when removed in a direction perpendicular to the surface of the circuit substrate, necessarily force the distal ends apart again until they spring against each other to an extent after (completely) departing through the stripped terminals. The distal ends are thus oriented somewhat perpendicular to the surface of the circuit substrate with respect to an adjacent portion of the retaining projections.

The choke coil can comprise a core assembly having an eye (bore) through which the conductors are guided. For example, three or four conductors can be guided through the eye and guided back on an exterior of the core assembly. Positioning aids or positioning structures can be provided in the eye, and/or on an end face of the core assembly, and/or on a lateral surface of the core assembly in order to facilitate accurate and predefined positioning of the conductor during the course of choke coil assembly. For example, the positioning structures can comprise bars and/or grooves. Said structures can extend in a radial direction on the end face and/or can extend in a direction coaxial to the eye on the jacket surface. In particular, if the core assembly has an elastic surface (e.g., made of a suitable plastic or the like), then the conductors can be fitted into the grooves, in particular, pressed, and prevented from accidentally loosening or (partially) bending back towards an initial shape of the conductor by a holding force of the positioning structures.

Preferably, the core assembly can further comprise positioning aids that facilitate positioning of the choke coil on the circuit substrate. In particular, predefined structures of the core assembly can engage with corresponding recesses in the circuit substrate so that a rotation-resistant positioning of the choke coil relative to the circuit substrate is enabled.

In particular, coding of a rotational position about a longitudinal axis can be performed by the eye of the choke coil during the course of assembly, thus permitting only a single rotational position of the choke coil with respect to the circuit substrate. An electrically incorrect association between the conductors and the terminal clips can be effectively prevented in this way.

Further preferably, the choke coil or core assembly can comprise a mechanical stop which cooperates with a corresponding structure (e.g., an edge/flange around a recess) on the circuit substrate. In other words, the choke coil can only be inserted into the recess through the circuit substrate to a certain predefined depth in this way until the stop rests against a surface of the circuit substrate (in particular, flatly). This flanged surface can be adhered to the circuit substrate. The flange prevents oscillations of the choke coil with respect to the circuit substrate and/or tilting of the choke coil with respect to the circuit substrate. In particular, it can be ensured that a design height of the choke coil has particularly low tolerances with respect to the surface of the circuit substrate.

The stripped terminals of the choke coil can each lead in a (star-shaped) radial direction from the coil along a common plane. In other words, the stripped terminals converge in a common plane which lies parallel to a surface of the circuit substrate. In this way, the plurality of terminal clips can also have an identical design and/or an identical height above the surface of the circuit substrate. The structure of the electrical arrangement is thereby again reduced. In this case, the stripped terminals or the terminal clips can in particular be arranged equidistant from one another. In other words, terminal clips adjacent to one another can each be at an identical angle to one another. In particular, the stripped terminals can be at a 45° angle to each other.

The electrical arrangement disclosed here can be preassembled using ordinary conductor pieces. The size of the parts must be adjusted to the current carrying capacity as well as the damping properties. The subsequent assembly process can be position-oriented and performed on a standard carrier (a circuit substrate, printed circuit board, pre-injected stamping part, or the like) and avoids a threaded assembly with intervening connection processes. The choke coil can during the final assembly process be joined with a canister structure provided for cooling and shielding. The latter component is then in its own EMV zone, which has an advantageous effect on damping.

### BRIEF DESCRIPTION OF THE DRAWINGS

Embodiment examples of the invention are described in detail hereinafter with reference to the accompanying drawings. The drawings show:

FIG. 1 a perspective view of a choke coil for use in an electrical arrangement according to the invention;

FIG. 2 a perspective view of a choke coil according to FIG. 1 from below;

FIG. 3, the arrangement shown in FIG. 2 after aligning the conductors guided through the eye of the coil core in a radial direction;

FIG. 4 a circuit substrate and a section view through a choke coil according to FIG. 3 in conjunction with a circuit substrate for double-sided mounting of the choke coil; and

FIG. 5 a perspective view of the components shown in FIG. 4 and an arrangement of the stripped conductor ends in additionally illustrated terminal clips.

### DETAILED DESCRIPTION

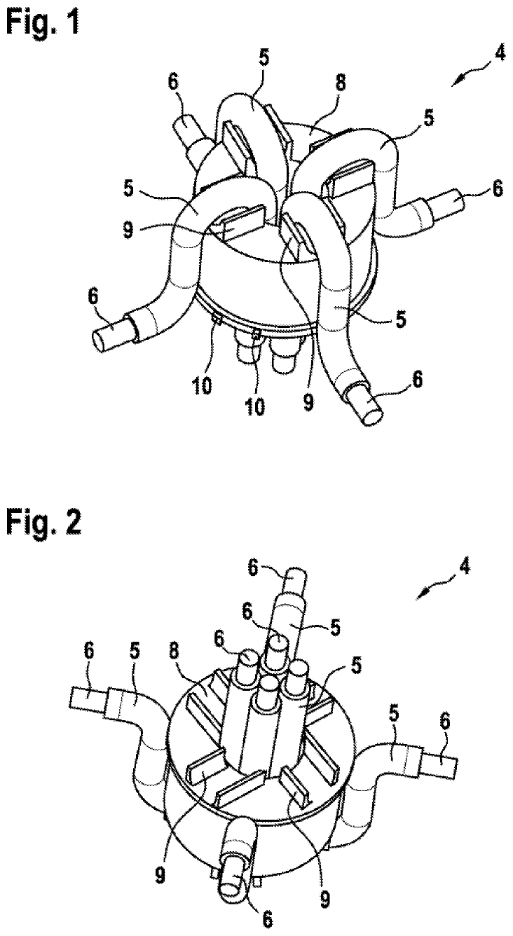

FIG. 1 shows a choke coil 4 having four electrical conductors 5, which comprise stripped terminals 6 on both sides. The conductors 5 are engaged in positioning structures 9 arranged on the end face of the core assembly 8. The positioning structures 9 are designed as pairs of parallel bars on both sides of the radially extending sections of the conductor 5. Two positioning aids 10 are further arranged on the core assembly 8, which engage recesses (not shown) of a board (not shown) and prevent rotational protection of the choke coil 4 with respect to the circuit board.

FIG. 2 shows the choke coil 4 shown in FIG. 1 in an overhead view. In addition, positioning structures 9 in the form of bars on the opposite end faces are also provided for the ends of the conductor 5, which are oriented in a coaxial direction in the arrangement depicted.

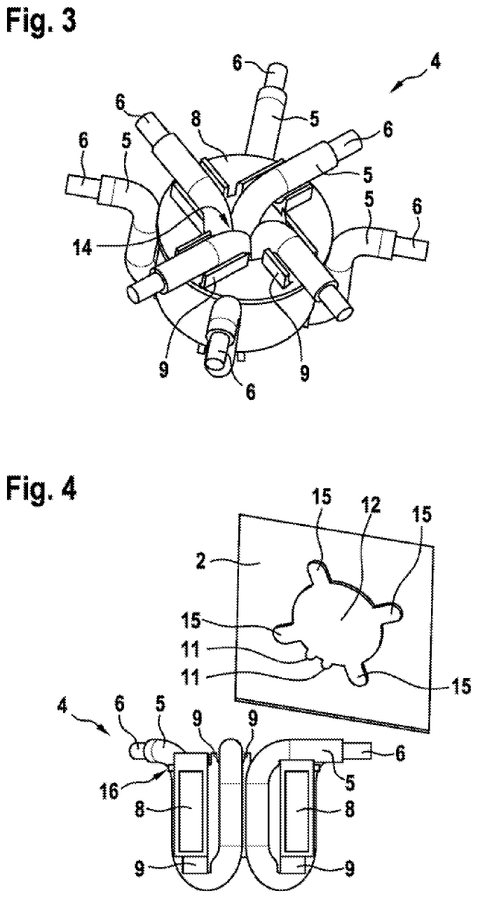

FIG. 3 shows the choke coil 4 shown in FIG. 2 after the conductors 5 projecting from the eye 14 of the core assembly 8 have bent into the grooves provided by the bars 9 and thus have reached a radial orientation. The stripped conductor ends 6 are then all located in a plane extending perpendicular to an axis through the eye 14 of the core assembly 8.

FIG. 4 shows a perspective view of a circuit substrate 2, which comprises two recesses 11 corresponding to the protruding positioning aids 10 (FIG. 2). An arrangement of the choke coil (as shown in the sectioned diagram) also comprising a stop 16 can thus only be achieved in one direction of rotation. In addition, the recess 12 comprises inlets for the sections of the conductor 5 extending outwardly on the core assembly 8. The conductors 5 are thereby secured in the circuit substrate 2 after the choke coil 4 is inserted into the recess 12. The joining geometry (totality of the recesses 11, 12 as well as the bays 15) in the circuit substrate 2 thus determines the position and orientation of the choke coil 4 in its end position. In the end position, the stop 16 can be adhered to the surface of the circuit substrate 2. Alternatively, a retaining projection can also be arranged on the core assembly 8, thus enabling a (provisional or final) fixation of the choke coil 4 on the circuit substrate 2.

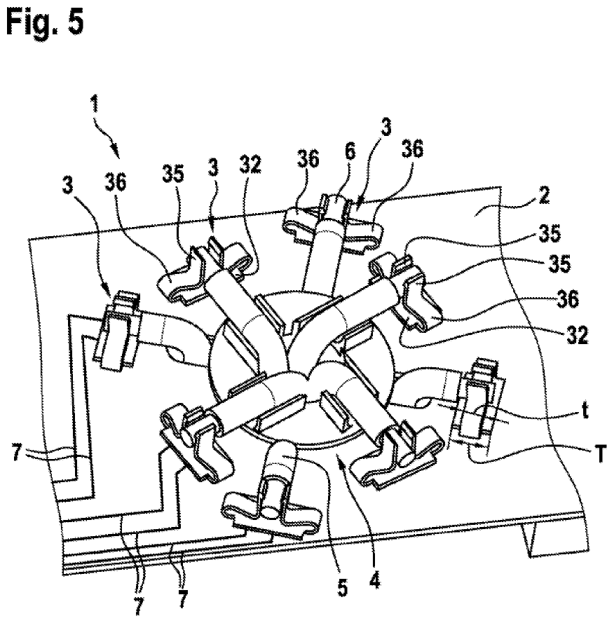

FIG. 5 illustrates the components shown in FIG. 4 after assembly, wherein the stripped terminals 6 are held in the terminal clips 3. The terminal clips 3 comprise a respective base 32 with a first (larger) depth T, to which at the opposite ends of which respective retaining projections 36 connect. The retaining projections 36 comprise distal ends 35 situated substantially perpendicular to a surface of the circuit substrate 2. The retaining projections 36 have a depth t, which is less than the depth T of the base 32. The retaining projections 36 initially curve over the respective base 32, whereas their distal ends 35 are bent upwards in the opposite direction in order to clamp the stripped terminals 6 in place. Three terminal clips 3 are connected to exemplary conductor traces 7 on the circuit substrate 2. The electrical contact resistance between the stripped terminals 6 and the terminal clips 3 can be further reduced by placing welding electrodes on the retaining projections 36 (and/or connecting to the distal ends 35), a welding current then connecting the components with one another in a bonded manner.

1. An electric arrangement (1) comprising:
a circuit substrate (2) with a plurality of terminal clips (3), and
a choke coil (4) with conductors (5) having stripped terminals (6), wherein each stripped terminal (6) is held in one of the plurality of terminal clips (3).

2. The electric arrangement according to claim 1, wherein the plurality of terminal clips (3) are electrically connected to a respective conductor trace (7) on the circuit substrate (2).

3. The electric arrangement according to claim 1, wherein the stripped terminals (6) are welded onto the terminal clips (3).

4. The electric arrangement according to claim 1, wherein
the terminal clips (3) and the choke coil (4) are arranged entirely on one side of the circuit substrate (2), or
the terminal clips (3) and a center of gravity of a core assembly (8) of the choke coil (4) are arranged on different sides of the circuit substrate (2).

5. The electric arrangement according to claim 1, wherein the terminal clips (3) comprise:
a flat base (32) adjoining the circuit substrate (2), and/or
retaining projections (36) which are located on opposite sides of the base (32) and curve over the base (32).

6. The electric arrangement according to claim 5, wherein the retaining projections (36)
have a depth (t) which is less than a depth (T) of the base (32), and/or
have distal ends (35) which are oriented substantially perpendicular to the base (32).

7. The electric arrangement according to claim 1, wherein the choke coil (4) comprises a core assembly with an eye (14), through which the conductors (5) are guided, wherein the core assembly (8) comprises positioning structures (9) into which the conductors (5) are inserted.

8. The electric arrangement according to claim 7, wherein the core assembly (8) comprises protruding positioning aids (10) which engage into corresponding recesses (11) in the circuit substrate (2).

9. The electric arrangement according to claim 1, wherein the choke coil (4) is guided through a recess (12) in the circuit substrate (2) to a side opposite to the terminal clips (3) with respect to the circuit substrate (2), and a core assembly (8) of the choke coil (4) comprises a stop (15) which adjoins a surface of the circuit substrate (2) on ae side of the terminal clips (3).

10. The electric arrangement according to claim 1, wherein the stripped terminals (6) are guided on a common plane in a star-shaped radial direction.

11. The electric arrangement according to claim 7, wherein the positioning structures (9) are on an end face and/or on a lateral surface of the core assembly (8).

12. The electric arrangement according to claim 7, wherein the conductors (5) are compressed in the positioning structures (9).
